(19) United States
(12) Patent Application Publication
(10) Pub. No.: US 2011/0184821 A1
(43) Pub. Date: Jul. 28, 2011

(54) PAYMENT DEVICE TRIGGERED MODIFIED TRANSACTION SESSION AT POINT OF SALE

(75) Inventors: Felix A. Mon, Jacksonville, FL (US); Jason Michael Ackiss, Matthews, NC (US); Maile George, Concord, CA (US); Robert Fleetwood Armstrong, Charlotte, NC (US); Kazi M. Ariff, Quincy, MA (US); Erik Stephen Ross, Charlotte, NC (US)

(73) Assignee: BANK OF AMERICA CORPORATION, Charlotte, NC (US)

(21) Appl. No.: 12/695,841

(22) Filed: Jan. 28, 2010

(51) Int. Cl. G06Q 20/00; G06Q 30/00; G06Q 40/00

(52) U.S. Cl. 705/17; 705/41; 705/21

(57) ABSTRACT

Systems, methods, and computer program products are provided for providing a modified transaction process or session for a consumer at a point of sale of a vendor when triggered by a consumer's transaction or payment device. The transaction device either stores consumer preference data or stores pointer data pointing to the network location of the consumer preference data. The transaction device communicates with the vendor's point of sale or payment terminal, and the payment terminal processes the consumer preference data. If the payment terminal determines the consumer prefers a modified transaction session, the payment terminal initiates the modified transaction session, which in various embodiments, includes one or both of communicating transaction information via consumer-readable communications proximate the consumer's mobile device and receiving consumer input proximate the consumer's mobile device and communicating the consumer input to the payment terminal for processing or other modifications to a typical transaction session.

### FIELD

In general, embodiments of the invention relate to point of sale transactions, and, more particularly, relate to systems, methods, and computer program products for providing a consumer with a modified transaction process when triggered by a transaction device indicating consumer preference for the modified transaction process.

### BACKGROUND

When engaged in a point-of-sale (POS) transaction, a consumer typically has the opportunity to review information regarding the goods and/or services being purchased on a video display as the products are scanned. The information provided to the consumer may include the name of the product being purchased, the quantity being purchased, the price of the product, discounts applied to the price of the product and other information. In some configurations, the video display is shared by both the cashier and the consumer, and the screen is turned so that both cashier and consumer may view the display. Typically the cashier is behind a counter opposite the consumer. In such a configuration, creating an unobstructed line of sight to the video display for both the cashier and the consumer may prove difficult. In other configurations, a separate video display is provided for both the cashier and the consumer. However, viewing the video display may be difficult or impossible for many consumers, such as consumers with visual impairment. Additionally, use of the video display may be difficult for consumers that are distracted, such as consumers having children. Various other consumers may simply prefer not to read the information provided on the video display. Furthermore, some consumers, including the visually impaired, may find use of a traditional payment terminal difficult or impossible. Therefore, systems and methods are needed to provide alternative ways for communicating transaction information to a consumer and assisting the consumer in providing input to the payment terminal in order to more easily complete the transaction at the POS. Additionally, systems and methods are needed to provide the consumer with a modified transaction process such as those discussed above when triggered by the consumer's transaction or payment device indicating the consumer's preference for a modified transaction process or session.

### SUMMARY

Systems, methods, and computer program products are provided for providing a modified transaction process or session for a consumer at a point of sale of a vendor when triggered by a consumer's transaction or payment device. The method includes receiving consumer preference data from the transaction device carried by the consumer; processing the consumer preference data to determine that the consumer prefers a modified transaction process; and modifying the transaction based at least in part on the consumer preference for a modified transaction process.

In some embodiments, the consumer preference data received from the transaction device includes information indicating the consumer preference regarding the modified transaction process. In some embodiments, the consumer preference data received from the transaction device comprises pointer data including information indicating a network location of remote preference data indicating the consumer preference. In such embodiments, processing the consumer preference data includes accessing the network location, retrieving the remote preference data, and processing the remote preference data to determine the consumer preference regarding the modified transaction process. In some embodiments, the modified transaction process comprises one or more selected from the group consisting of an audible transaction process, a visual recognition audible transaction process, and a mobile device consumer interface transaction process. In yet other embodiments, the transaction device is one or more loyalty devices, magnetic-based payment devices, credit cards, debit cards, personal identification number (PIN) payment devices, contactless payment devices, key fobs, radio frequency identification devices (RFID), mobile devices, smartphones, cellular phones, personal digital assistant (PDA) devices, Moving Picture Experts Group Layer-3 Audio (MP3) devices, and personal global positioning system (GPS) devices.

In some other embodiments, the consumer preference data is received from the transaction device of the consumer proximate an onset of the transaction and the consumer preference for a modified transaction process is determined proximate the onset of the transaction such that substantially all of the transaction is modified based at least in part on the consumer preference for a modified transaction process. In yet other embodiments, processing the consumer preference data includes determining the consumer's preference for a modified transaction process for a future transaction.

In accordance with other embodiments of the invention, an apparatus provides a modified transaction process between a consumer carrying a transaction device and a vendor during a transaction at a point of sale and includes means for receiving consumer preference data from the transaction device carried by the consumer; means for processing the consumer preference data to determine that the consumer prefers a modified transaction process; and means for modifying the transaction based at least in part on the consumer preference for a modified transaction process. In some embodiments, the consumer preference data received from the transaction device comprises information indicating the consumer preference regarding the modified transaction process. In other embodiments, the consumer preference data received from the transaction device comprises pointer data including information indicating a network location of remote preference data indicating the consumer preference, and the apparatus further comprises means for accessing the network location, means for retrieving the remote preference data, and means for processing the remote preference data to determine the consumer preference regarding the modified transaction process.

In one embodiment, the modified transaction process comprises one or more selected from the group consisting of an audible transaction process, a visual recognition audible transaction process, and a mobile device consumer interface transaction process. In another embodiment, the transaction device includes one or more selected from the group consisting of loyalty devices, magnetic-based payment devices, credit cards, debit cards, personal identification number (PIN) payment devices, contactless payment devices, key fobs, radio frequency identification devices (RFID), mobile devices, smartphones, cellular phones, personal digital assistant (PDA) devices, Moving Picture Experts Group Layer-3 Audio (MP3) devices, and personal global positioning system (GPS) devices.

In accordance with other embodiments of the invention, a system provides a modified transaction process between a consumer carrying a transaction device and a vendor during a transaction at a point of sale. The system includes a payment terminal disposed proximate the point of sale that includes an input device configured for receiving consumer preference data from the transaction device carried by the consumer; a processing device configured for processing the consumer preference data to determine that the consumer prefers a modified transaction process. In these embodiments, the processing device is further configured for modifying the transaction based at least in part on the consumer preference for a modified transaction process.

In some embodiments, the consumer preference data received by the input device from the transaction device includes information indicating the consumer preference regarding the modified transaction process, and in others, the consumer preference data received by the input device from the transaction device comprises pointer data including information indicating a network location of remote preference data indicating the consumer preference. In some embodiments, the payment terminal further comprises a communication device configured for accessing the network location and retrieving the remote preference data, and the processing device is further configured for processing the remote preference data to determine the consumer preference regarding the modified transaction process.

In other embodiments, the modified transaction process comprises one or more selected from the group consisting of an audible transaction process, a visual recognition audible transaction process, and a mobile device consumer interface transaction process. In some embodiments, the transaction device comprises one or more selected from the group consisting of loyalty devices, magnetic-based payment devices, credit cards, debit cards, personal identification number (PIN) payment devices, contactless payment devices, key fobs, radio frequency identification devices (RFID), mobile devices, smartphones, cellular phones, personal digital assistant (PDA) devices, Moving Picture Experts Group Layer-3 Audio (MP3) devices, and personal global positioning system (GPS) devices. In some other embodiments, the transaction device comprises a consumer preference device configured for storing and communicating the consumer preference data.

In accordance with other embodiments of the invention, a computer program product includes a computer-readable medium including computer-readable instructions for providing a modified transaction process between a consumer carrying a transaction device and a vendor during a transaction at a point of sale. The instructions include instructions for receiving consumer preference data from the transaction device carried by the consumer; instructions for processing the consumer preference data to determine that the consumer prefers a modified transaction process; and instructions for modifying the transaction based at least in part on the consumer preference for a modified transaction process.

In some embodiments, the consumer preference data received from the transaction device comprises information indicating the consumer preference regarding the modified transaction process. In other embodiments, the consumer preference data received from the transaction device comprises pointer data including information indicating a network location of remote preference data indicating the consumer preference and the instructions include instructions for accessing the network location; instructions for retrieving the remote preference data; and instructions for processing the remote preference data to determine the consumer preference regarding the modified transaction process.

In some embodiments, the instructions for modifying the transaction comprise one or more selected from the group consisting of instructions for performing an audible transaction process, instructions for performing a visual recognition audible transaction process, and instructions for performing a mobile device consumer interface transaction process. In some embodiments, the transaction device comprises one or more selected from the group consisting of loyalty devices, magnetic-based payment devices, credit cards, debit cards, personal identification number (PIN) payment devices, contactless payment devices, key fobs, radio frequency identification devices (RFID), mobile devices, smartphones, cellular phones, personal digital assistant (PDA) devices, Moving Picture Experts Group Layer-3 Audio (MP3) devices, and personal global positioning system (GPS) devices.

In accordance with other embodiments of the invention, a system disposed at a point of sale of a vendor provides a modified transaction process between a consumer carrying a transaction device and the vendor during a transaction at the point of sale. The system includes an input device configured for receiving consumer preference data from the transaction device carried by the consumer; a processing device configured for processing the consumer preference data to determine that the consumer prefers a modified transaction process; and the processing device further configured for modifying the transaction based at least in part on the consumer preference for a modified transaction process.

In some embodiments, the consumer preference data received by the input device from the transaction device comprises information indicating the consumer preference regarding the modified transaction process. In other embodiments, the consumer preference data received by the input device from the transaction device comprises pointer data including information indicating a network location of remote preference data indicating the consumer preference. In these embodiments, the system includes a communication device configured for accessing the network location and retrieving the remote preference data, and the processing device is further configured for processing the remote preference data to determine the consumer preference regarding the modified transaction process.

In some embodiments, the modified transaction process comprises one or more selected from the group consisting of an audible transaction process, a visual recognition audible transaction process, and a mobile device consumer interface transaction process. In some embodiments, the transaction device comprises one or more selected from the group consisting of loyalty devices, magnetic-based payment devices, credit cards, debit cards, personal identification number (PIN) payment devices, contactless payment devices, key fobs, radio frequency identification devices (RFID), mobile devices, smartphones, cellular phones, personal digital assistant (PDA) devices, Moving Picture Experts Group Layer-3 Audio (MP3) devices, and personal global positioning system (GPS) devices. In some embodiments, the system includes a payment terminal configured for receiving payment information from the consumer and finalizing the transaction. In other embodiments, the transaction device includes a consumer preference device configured for storing and communicating the consumer preference data.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a flow diagram illustrating an audible transaction process, in accordance with one embodiment of the present invention;

FIG. 2 is a block diagram providing a more detailed illustration of an audible transaction system, in accordance with one embodiment of the present invention;

FIG. 3 is a block diagram providing a more detailed illustration of an audible transaction system, in accordance with another embodiment of the present invention;

FIG. 4 is a flow diagram illustrating a visual recognition audible transaction process, in accordance with one embodiment of the present invention;

FIG. 5 is a flow diagram illustrating a mobile device consumer interface transaction process, in accordance with one embodiment of the present invention;

FIG. 6 is a flow diagram illustrating a process for providing a consumer a modified transaction process;

FIG. 7 is a block diagram providing an illustration of a system for providing a consumer with a modified transaction process; and

FIG. 8 is a flow diagram illustrating a method for processing consumer preference data.

### DETAILED DESCRIPTION OF EMBODIMENTS OF THE INVENTION

Embodiments of the present invention now will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

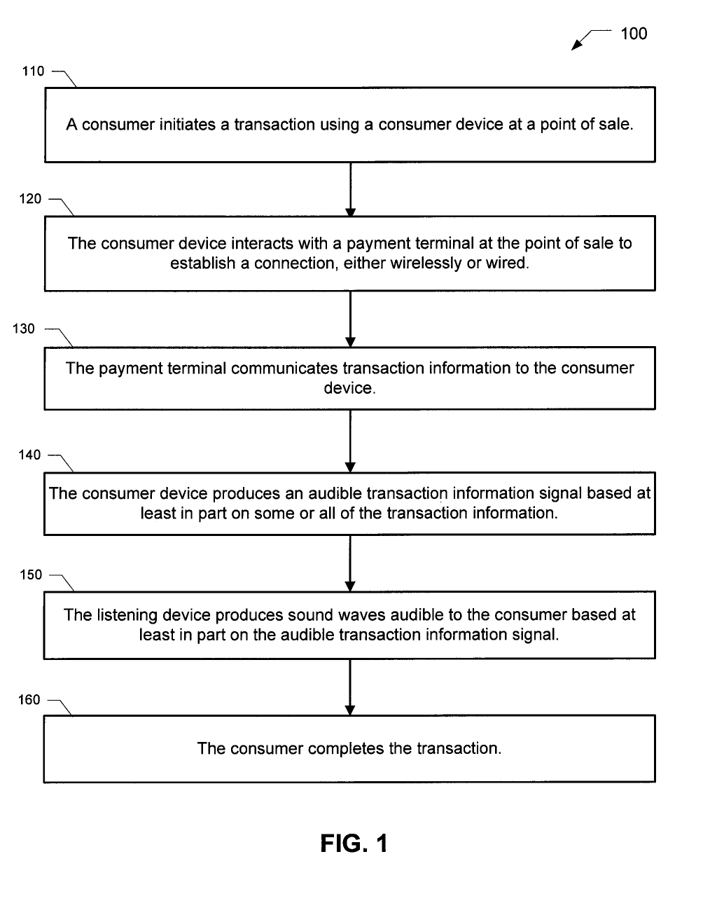

FIG. 1 is a flow diagram illustrating an audible transaction process 100 in accordance with one embodiment of the present invention. As represented by block 110, a consumer initiates a transaction using a consumer device at a point of sale. For example, the consumer may initiate a transaction to purchase goods or services from a vendor. In one embodiment, a consumer approaches the point of sale carrying a consumer device such as a cellular phone, smartphone, personal digital assistant (PDA), personal navigation device such as a global positioning system (GPS) receiver, personal music player such as a Moving Picture Experts Group Layer-3 Audio (MP3) player, or the like and requests the purchase of goods and/or services. In some embodiments, the consumer device is a wireless communication device and in others the consumer device is configured for connecting via a wired connection. In some embodiments, the consumer device is part of the point of sale and is not a mobile device carried by the consumer.

As used herein, “transaction” refers to any interaction between a consumer and vendor proximate the vendor's point of sale. For example, a consumer may interact with a payment terminal proximate the point of sale of the vendor in order to receive transaction information and provide consumer input. As used herein, “payment terminal” refers to any terminal proximate the point of sale and operated by the vendor in order to interact with one or more consumers. For example, in some embodiments, a payment terminal may include, but is not limited to, a keypad, a monitor, a card-reading device and the like. In some embodiments, a payment terminal includes one or more of a processing device, a communication device, an input device and other components or one or more of those components are separate from the payment terminal and are configured for communicating with the payment terminal.

As represented by block 120, the consumer device interacts with a payment terminal at the point of sale, via either a wireless or wired connection. In one embodiment the user device is configured for a wired connection. In such a configuration, the consumer physically connects the consumer device with the payment terminal. For example, in one embodiment, the payment terminal includes a universal serial bus (USB) cable for connecting with a consumer device, and the consumer recognizes the cable and connects the consumer device via the USB cable. In other embodiments, the consumer device connects with the payment terminal wirelessly. Such a connection can be initiated by either the consumer device or the payment terminal. For example, in one embodiment the consumer device is a smartphone having wireless communication capabilities. The smartphone recognizes the presence of the payment terminal at the point of sale and begins wireless communication with the payment terminal. In another embodiment the payment terminal at the point of sale recognizes the presence of the consumer device and begins wireless communication with the consumer device.

In some embodiments, the interaction between the consumer device and the payment terminal includes authentication of the identity of the consumer. The type of authentication varies drastically across various points of sale. For example, in one embodiment, the identity of the consumer is authenticated by the consumer using the consumer device to communicate some type of security code such as a PIN number or answer one or more security questions. Authentication can be performed using one security measure or multiple security measures. For example, in one embodiment, two security measures are required. The consumer device, in this example, is a consumer's mobile device and during interaction with the payment terminal, the mobile device communicates identification information to the payment terminal. Additionally, the consumer is prompted by the mobile device, typically upon receipt of instructions from the payment terminal, to enter either a PIN number or some other consumer input tending to identify the consumer. In some embodiments other types of security measures are used such as, but not limited to, biometrics, iris recognition, fingerprinting and the like.

As represented by block 130, once the consumer device and the payment terminal have established a connection, the payment terminal communicates transaction information to the consumer device. For example, a consumer may be purchasing goods from a cashier in a store. As the goods are scanned, the payment terminal communicates information related to the products being scanned, such as information indicating the name of the product being scanned and the price of the product being scanned. Once all the goods have been scanned at the point of sale in order to identify the goods, the payment terminal determines the balance owed for the transaction. Then, the payment terminal communicates transaction information including, but not limited to, product identification information, product quantity information, product pricing information, product discount information, running balance owed information, final balance owed information, and payment method information.

As represented by block 140, the consumer device then produces an audible transaction information signal based at least in part on some or all of the transaction information received from the payment terminal.

As represented by block 150, the listening device produces sound waves audible to the consumer based at least in part on the audible transaction information signal received from the consumer device. In some embodiments, the consumer device includes the listening device for audibly communicating the information to the consumer. In some embodiments, the consumer device includes a listening port such as a headphone jack so that the consumer may receive the audible information via headphones, headset, earphones, ear-buds, hearing assistance devices such as hearing aids or the like. In some embodiments, the listening device includes a personal listening device such as a set of headphones, a headset, earphones, ear-buds, hearing assistance devices such as hearing aids, one or more personal speakers or the like for connecting with the consumer device and providing audible sound waves to the consumer. In other embodiments, the listening device is a public listening device such as one or more public speakers or some other public listening device that publishes sound waves into surrounding areas so that any person proximate the area might listen. Herein a personal speaker refers to a low-output speaker configured for providing audible sound waves predominantly to an individual while minimizing public exposure to the sound waves. A public speaker refers herein to a speaker having a higher output than a personal speaker such that individuals other than the consumer may be exposed to the sound waves it produces. In the private listening embodiments, discretion is maintained because other nearby consumers need not become aware that the consumer is utilizing an audible transaction process 100. For example, as products are being scanned at the point of sale, the consumer device, which is connected with or includes a personal listening device, provides audible information to the consumer without nearby people being exposed to public messages concerning the transaction, thereby maintaining a high degree of discretion.

As represented by block 160, the consumer then completes the transaction. In some embodiments, the consumer device prompts the consumer to provide account information for payment of the balance owed. Then, the consumer may enter bank account information such as credit or debit account information. In some embodiments, the consumer device stores information regarding a particular credit or debit account from which the vendor can obtain payment. In such embodiments, the consumer device can be configured to prompt the consumer to choose the account from which the consumer desires payment to be made, or the consumer device can be configured to automatically provide payment from a predetermined account.

As used herein, a “bank account” refers to a credit account, a debit/deposit account, or the like. Although the phrase “bank account” includes the term “bank,” the account need not be maintained by a bank and may, instead, be maintained by other financial institutions. As used herein, unless specifically limited by the context, a “transaction” may refer to a purchase of goods or services, a return of goods or services, a payment transaction, a credit transaction, or other transaction involving the consumer's bank account. As used herein, the term “products” refers to both goods and services.

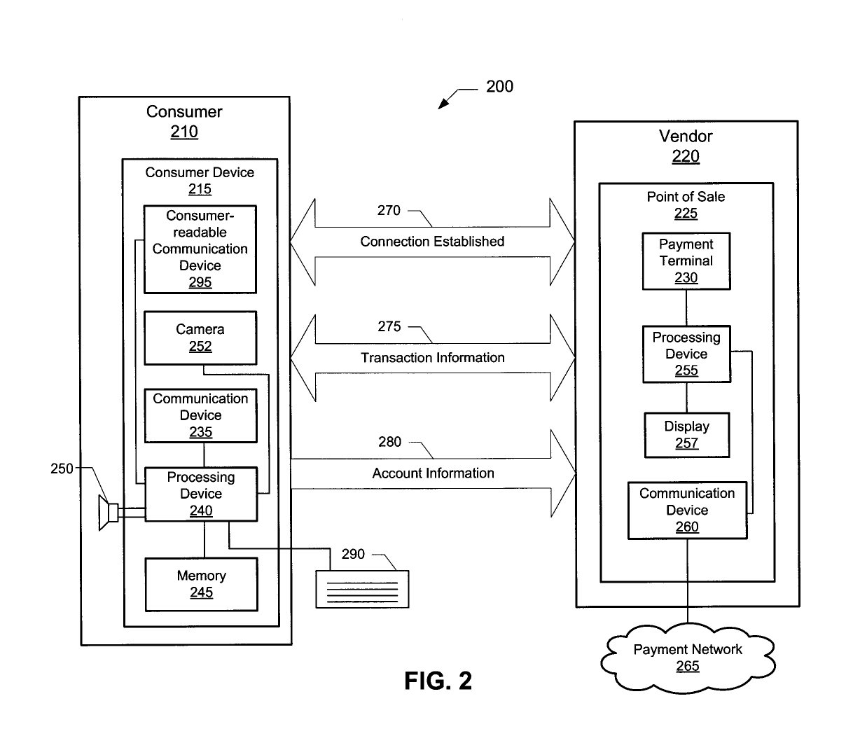

FIG. 2 is a block diagram providing a more detailed illustration of an audible transaction system 200 in accordance with one embodiment of the invention. In general, the audible transaction system 200 includes a consumer 210 with a consumer device 215 and a vendor 220 having a point of sale 225 including a payment terminal 230. In the embodiment illustrated in FIG. 2A, the consumer device 215 is shown alongside the consumer 210 to indicate that the consumer device 215 is a mobile device that can be transported by the consumer 210. As discussed above, the consumer device 215 can be any number of mobile devices.

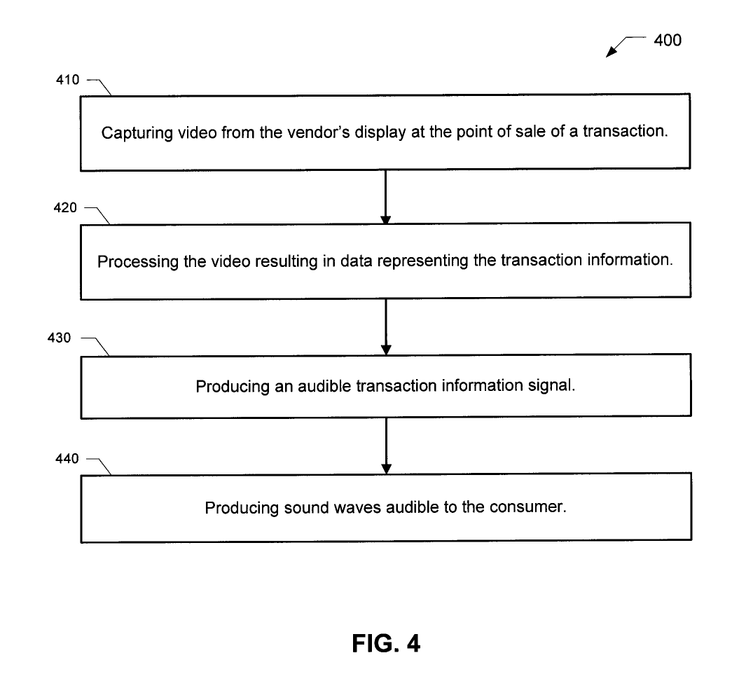

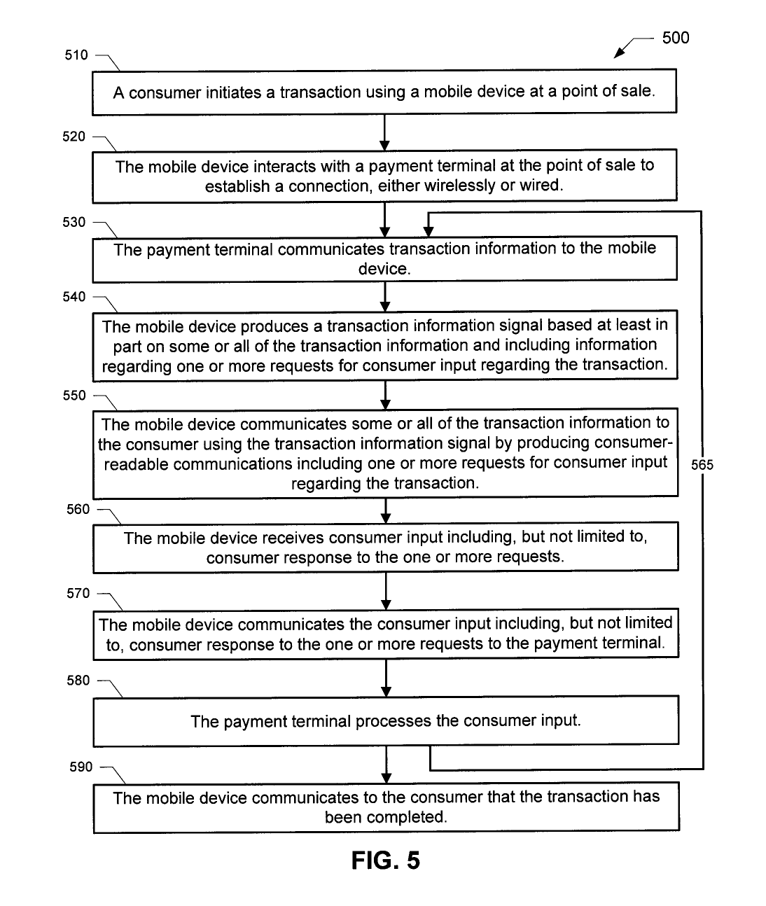

In this embodiment, the consumer device 215 includes a communication device 235, a processing device 240, a memory 245, and a listening device 250. In some embodiments, such as the embodiment discussed below with reference to FIG. 4, the consumer device includes a camera 252. In some embodiments, such as the embodiment discussed below with reference to FIG. 5, the consumer device is a mobile device and either includes or is configured for communicating with an input device 290 and a consumer-readable communication device 295. The processing device 240 is connected with and generally controls the operation of the other components of the consumer device 215.

As used herein, a “processing device” generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities.

As used herein, a “communication device” generally includes a modem, server, transceiver, and/or other device for communicating with other devices directly or via a network, and/or a user interface for communicating with one or more users. As used herein, a “user interface” generally includes a display, mouse, keyboard, button, touchpad, touch screen, microphone, speaker, LED, light, joystick, switch, buzzer, bell, and/or other user input/output device for communicating with one or more users.

As used herein, a “memory device” generally refers to a device or combination of devices including one or more forms of computer-readable media for storing instructions, computer-executable code, and/or data thereon. Computer-readable media is defined in greater detail herein below. It will be appreciated that, as with the processing device, each communication interface and memory device may be made up of a single device or many separate devices that conceptually may be thought of as a single device.

In the embodiment of the invention illustrated in FIG. 2, a processing device 255 is also located at the point of sale 225 and connected with the payment terminal 230. Some embodiments also have a display 257 connected with the payment terminal 230 and/or the processing device 255 for displaying some or all of the transaction information in a visually perceptible format. The processing device 255 is also connected with and controls a communication device 260 configured for communicating with a payment network 265. One of skill in the art will recognize, in view of this disclosure, that one embodiment of the payment network 265 includes communication pathways to and from both an acquiring bank, which manages the vendor's bank account, and an issuing bank, which manages the consumer's credit/debit account.

When the consumer 210 initiates a transaction, such as a payment transaction to pay for a product provided by the vendor 220, or a return transaction for returning a product to the vendor 220, the communication device 235 of the consumer device 215 establishes a connection (arrow 270) with the communication device 260 at the POS 225 of the vendor 220. In the wireless embodiment, this step typically begins with the processing device 240 controlling the communication device 235 so that the communication device 235 “listens” for communications from an outside communication device (such as 260) and/or transmits so that outside communication devices (such as 260) can recognize the presence of the consumer device 215. In one embodiment, radio frequency identification (RFID) devices are used as one or both of the communication devices 235 and 260 or are connected with one or both of the communication devices 235 and 260 to provide indications of the proximity of a consumer device 215 with a payment terminal 230. When communication device 235 recognizes the presence of a POS communication device 260, the connection can be established.

In other embodiments, the consumer device 215 connects via wired connection. For example, the consumer brings a consumer device 215 to the point of sale 225 and manually connects the consumer device 215 with the payment terminal 230 or the communication device 260. In one embodiment discussed above, the point of sale includes a communication device 260 such as a USB port and a USB cable for connecting with the USB port at the point of sale on one end and connecting with the consumer device 215 on the opposite end.

Once the consumer device 215 is connected with the payment terminal 230, the payment terminal 230 communicates transaction information to the consumer device 215 (arrow 275). The communication of transaction information may be prompted in several ways. In a first embodiment, the communication of transaction information is prompted automatically once both initiation of the transaction and a connection is established between the consumer device 215 and the payment terminal 230.

In a second embodiment, a consumer's card may prompt the audible transaction process once it has been swiped by the cashier or the consumer. The card may be swiped before or during the transaction process, and communicates to the payment terminal 230 that an audible transaction process is the consumer's preference. In one embodiment, the consumer's card is a credit/debit card that is being used to transfer account information for tendering payment for the transaction. In another embodiment, the consumer's card is a membership card such as a grocery store discount card. In various embodiments, the consumer card, (credit/debit card, membership card, or some other consumer card) has a memory such as a flash memory with stored consumer preferences indicating that an audible transaction process is preferred to the typical, visually-based transaction process. In various other embodiments, the consumer card indicates to the payment terminal 230, via access to an outside information source such as a remote database perhaps storing preferences for many consumers and maintained by the card-issuer, the consumer's preference for an audible transaction process. With regard to any of these embodiments, the consumer card may be swiped before or during the transaction and indicates to the payment terminal 230 the consumer's desire for an audible transaction process. It will be appreciated that, although a card is described herein, other devices may be used to indicate the consumer's preference for an audible transaction, such as other payment devices including, but not limited to, near-field-communication (NFC) payment devices. In one embodiment, the consumer device 215 is used as a NFC payment device and communicates the consumer's preference for audible transactions.

In a third embodiment, the consumer's preference for an audible transaction process may be prompted by the consumer plugging-in a personal listening device such as headphones, ear-buds or the like to the consumer device 215. When the consumer device 215 is already connected with a payment terminal 230 (arrow 270) upon connection of the personal listening device with the consumer device 215, the consumer device 215 indicates to the payment terminal 230 the consumer's preference for an audible transaction process, which is inferred from the consumer's plugging-in of the personal listening device. In another embodiment, the consumer device 215 prompts the consumer, either with a visual prompt, an audible prompt, a tactile prompt, or a combination of prompts, to choose whether to proceed with an audible transaction process once the personal listening device is connected. Then, the consumer device 215 receives the consumer input, either through speech recognition methods or via an input device, such as a keypad or touch-screen, and communicates the consumer's preference for proceeding with an audible transaction process if the consumer so chooses.

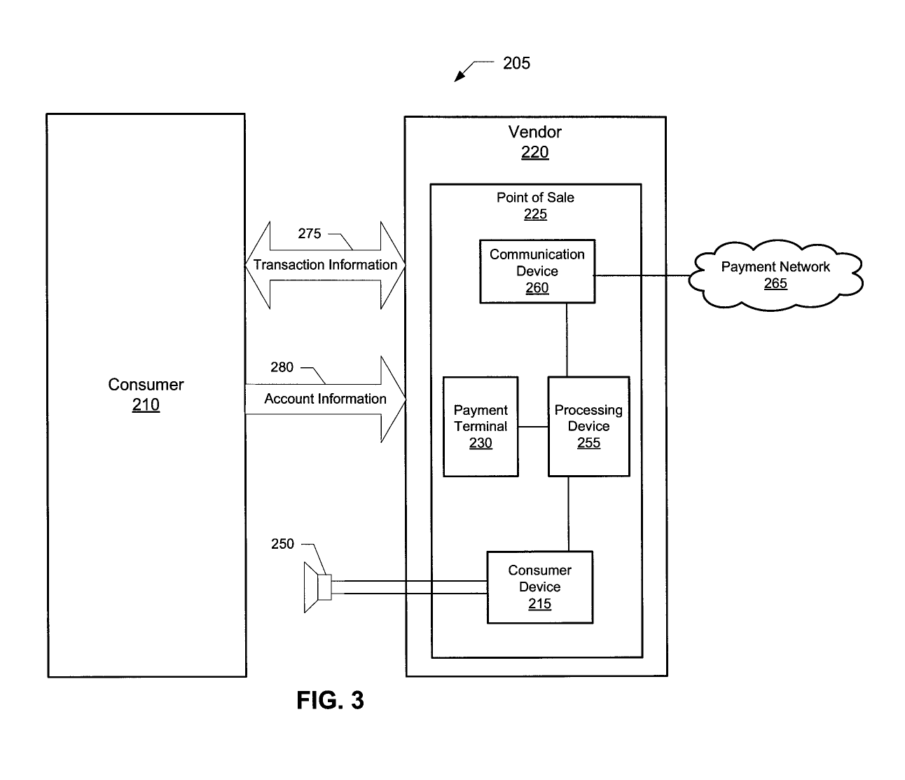

FIG. 3 is a block diagram providing a more detailed illustration of an audible transaction system 205 in accordance with another embodiment of the invention. In this embodiment, the consumer device 215 is located proximate the point of sale 225. In one embodiment, the consumer device 215 includes a pre-connected listening device 250, and in another embodiment, the consumer device 215 is configured for connecting with a listening device 250, such as a personal listening device. For example, in one embodiment, the consumer device 215 includes a headphone jack for connecting with a pair of headphones, which is one embodiment of the listening device 250.

When a consumer 210 initiates a transaction in this embodiment, the consumer 210 can prompt an audible transaction process in several ways. First, the consumer 210 can connect a listening device 250 with the consumer device 215 at the point of sale 225. The listening device 250 can be headphones, ear-buds or some other listening device. Second, the consumer 210 or the cashier can swipe the consumer's card or otherwise read the consumer's payment device or rewards device. As discussed above, the consumer's card can be a credit/debit card, a membership card, or the like. The card or other device either has stored preferences that are provided to the payment terminal 230 or is linked to pre-determined consumer preferences stored external to the system 205. Third, the system 205 can be configured to automatically operate with an audible transaction process. Fourth, the system 205 can prompt the consumer, audibly, visually or otherwise, to specify a preference by providing input either audibly or with some type of user input device such as a keypad, touch-screen or the like.

In another embodiment, the listening device 250 is already connected with the consumer device 215 at the point of sale 225. The listening device 250 in this embodiment can be one or more speakers, headphones, ear-buds or the like. In this embodiment, the second through fourth mechanisms of initiating an audible transaction process discussed above can be used. Specifically, the consumer 210 can swipe a card, indicating the consumer's preference, the system 205 can be automatically configured, or the system 205 can prompt the consumer 210 for input regarding preference.

FIG. 4 is a flow diagram illustrating a visual recognition audible transaction process 400. In this embodiment, the camera 252 of the consumer device 215 is configured for capturing video from the vendor's display 257 at the point of sale 225, as represented by block 410. As used herein the term “video” is an inclusive term intended to refer to one or more videos, one or more still images and/or one or more snapshot images taken from one or more videos. In some embodiments, the consumer device 215 is part of the vendor's point sale 225 as discussed with reference to FIG. 3, and the consumer device 215 includes a camera 252 for capturing the display 257. In other embodiments, the consumer device is separate from the point of sale 225, but the point of sale 225 includes a camera 252 connected with either the payment terminal 230 or the processing device 255 for capturing the video from the display 257. The video on the display 257 typically includes some or all of the transaction information.

For example, in one embodiment, the consumer device 215 includes a camera 252 for capturing the video display, as represented by block 410. The consumer 210 places the consumer device 215 within visual range of the vendor's display 257, and the camera 252 captures the video. The next step in the process, represented by block 420 is processing the video resulting in data representing the transaction information. This step is performed either by the consumer device 215 after capturing the video, or in embodiments where the camera 252 is part of the point of sale 225, by the processing device 255 at the point of sale 225. This may include performing an algorithm to convert any textual information captured from the display 257 into data representing the transaction information in an audible format. In this regard, some embodiments of the consumer device 215 include an image character recognition application stored in the memory 245 for processing video received from the camera, identifying transaction information therefrom, and converting the transaction information into an audio signal. In some embodiments, the camera 252 captures still images or screenshots from the display 257. In some of these embodiments, some or all captured still images are analyzed in order to discern any data representing transaction information.

The data representing the transaction information is then used to produce an audible transaction information signal as represented by block 430. Step 430 is performed by the processing device 240 of the consumer device 215 in embodiments where the camera 252 is part of the consumer device 215, and is performed by the processing device 255 at the point of sale in embodiments where the camera 252 is part of the point of sale 225. Finally, as represented by block 440, the audible transaction information signal is used to produce sound waves audible to the consumer 210. The listening device 250 receives the audible transaction information signal and produces sound waves audible to the consumer 210.

Referring now to FIG. 5, a flowchart of a mobile device consumer interface transaction process 500 in accordance with one embodiment of the invention is illustrated. As represented by block 510, a consumer initiates a transaction using a mobile device at a point of sale. As discussed above with reference to FIG. 1, the consumer approaches the point of sale carrying a device, which in this embodiment is a mobile device such as a cellular phone, smartphone, PDA, personal navigation device such as a GPS receiver, personal music player such as an MP3 player, or the like. The consumer then initiates a transaction by requesting purchase of goods and/or services.

As represented by block 520, the mobile device then interacts with a payment terminal at the point of sale to establish a connection, via either a wireless or wired connection as discussed above with reference to FIG. 1. When the mobile device is connecting wirelessly with the payment terminal, the connection can be initiated by either the mobile device or the payment terminal as discussed above. As discussed above with reference to FIG. 1, the interaction between the mobile device and the payment terminal includes authentication of the identity of the consumer in some embodiments.

As represented by block 530, once the mobile device and the payment terminal have established a connection, the payment terminal communicates transaction information to the mobile device. The transaction information may include, but is not limited to, product identification information, product quantity information, product pricing information, product discount information, running balance owed information, final balance owed information, and payment method information. In some embodiments, the transaction information also includes one or more requests for consumer input regarding some aspect of the transaction. For example, in one embodiment, as part of the transaction process, the vendor allows the consumer to request cash back to be drawn from the debit account the consumer is using to pay for a purchase of products. In this example, the transaction information includes information indicating that the cash back option is available and giving the consumer the option to choose whether he or she would like cash back. The transaction information, in some embodiments, also includes details concerning the cash back option such as the several levels of cash back from which the consumer will be allowed to choose.

As represented by block 540, the mobile device then produces a transaction information signal based at least in part on some or all of the transaction information and, in some embodiments, including information regarding one or more requests for consumer input regarding the transaction. In some embodiments, the payment terminal, rather than the mobile device produces the transaction information signal and then communicates the transaction information signal to the mobile device in conjunction or in place of step 530. In some embodiments, the transaction information signal is an analog signal and in others it is a digital signal or a combination of the two as discussed in greater detail below.

Next, as represented by block 550, the mobile device communicates some or all of the transaction information to the consumer using the transaction information signal by producing consumer-readable communications via the consumer-readable communication device 295 shown in FIG. 2. The transaction information signal, in some embodiments, includes instructions for producing consumer-readable communications. The instructions, in some embodiments, are digital instructions that can be processed and used to produce the consumer-readable communications. In other embodiments, the instructions are analog instructions that can be received by a consumer-readable communication device and used to produce consumer-readable communications without additional processing.

For example, in one embodiment, the payment terminal produces the transaction information signal in an analog format including instructions for a listening device such as a speaker. The payment terminal communicates the transaction information signal to the mobile device and the mobile device produces the consumer-readable communication, that is, sound waves audible to the consumer, via a speaker either integral or connected with the mobile device. In another embodiment, for example, the payment terminal produces the transaction information signal in a digital format including instructions for a tactile communication device such as a Braille device to produce a consumer-readable communication. The payment terminal communicates the transaction information signal to the mobile device, which then processes the signal and produces a consumer-readable communication using a tactile communication device either integral to the mobile device or connected with the mobile device.

The consumer-readable communications, in various embodiments, include one or more requests for consumer input regarding the transaction. In some embodiments, the request(s) is/are related to the transaction information, and in some embodiments, the requests are unrelated to the transaction information. For example, in some embodiments, the requests include requests for the consumer's personal information so that demographic information may be compiled and later analyzed.

As used herein, “consumer-readable communications” refers to any communication(s) produced by the consumer-readable communication device 295 of FIG. 2 and recognizable by the consumer via the consumer's senses. Such consumer-readable communications take many different forms, including, but not limited to visual communications such as video from a display of the mobile device, audible communications such as sound waves produced by a listening device, either personal or public, either part of the mobile device or separate, and tactile communications, such as those produced by a Braille-creating device, either part of the mobile device or separate. In some embodiments, the consumer-readable communications include communications intended to illicit a response from the consumer's sense of taste and/or sense of smell using a taste-creating device and/or a smell-creating device. In such embodiments, for example, the mobile device may include one or more chemical stores that are provided to the consumer based on the transaction information. For example, in one embodiment, the mobile device includes chemical stores for approximating the flavor and/or smell of two types of food products. The mobile device communicates with flavor and/or smell, and thereafter provides the consumer a choice between the two types of food products. In these various embodiments, the display, listening device, Braille-creating device, smell-creating device and/or taste-creating device are all examples of consumer-readable communication devices 295, but these examples are not exhaustive. Any device that produces a consumer-readable communication as defined above is considered a “consumer-readable communication device” as used herein.

As represented by block 560, the mobile device next receives consumer input including, but not limited to, consumer response to the one or more requests included in the consumer-readable communications of step 550. Consumer input is received via input device 290 shown in FIG. 2. The input device 290 may be part of the mobile device or may be separate and configured for communicating with the mobile device. The input device 290, in various embodiments, includes or is a keyboard, a touch-screen, a roller-ball, one or more buttons, a microphone configured for receiving audible input, a mouse, a touch-pad, an eye-movement sensing device configured for receiving input such as a pair of eye-glasses for measuring eye movement, one or more motion sensing devices such as one or more accelerometers configured for receiving input based on movement of the input device by the consumer, or any other device configured for receiving consumer input. For example, in one embodiment, the mobile device has communicated to the consumer by producing a consumer-readable communication (step 550) the option for cash-back during the course of a pending transaction. The consumer is prompted, via the consumer-readable communication, to input the consumer's choice whether to receive cash back. The consumer is given the option of choosing “yes” or “no.” In some embodiments, the consumer-readable communication indicates to the consumer that his or her answer may be spoken. In others, the communication indicates to the consumer that his or her answer may be typed into a keyboard or touch-screen device or entered physically in some other manner. The mobile device then receives the consumer's input regarding whether the consumer prefers cash back during the transaction.

In some embodiments of the process 500, as represented by arrow 565, several steps are repeated based on the interaction between the consumer, the mobile device and the payment terminal. For example, in some embodiments, steps 530-580 are repeated one or more times.

As represented by block 570, once the mobile device has received consumer input, the mobile device communicates to the payment terminal the consumer input including, but not limited to, consumer response to the one or more requests. Next, as represented by block 580, the payment terminal processes the consumer input. For example, in one embodiment, the payment terminal processes the consumer input indicating a positive desire for cash back. The payment terminal determines that the process should revert to step 530 in order to communicate the cash back levels available to the consumer and receive consumer input regarding desired level. In some embodiments, once all necessary iterations of the process have been completed, the mobile device communicates to the consumer that the transaction has been completed as represented by block 590.

In one exemplary embodiment of the invention described above with reference to FIGS. 2 and 5, the payment terminal is configured to communicate information to the mobile device that can be used by the mobile device to present the same information to the consumer through user interface devices integral with or coupled to the mobile device as is or would otherwise be presented to the consumer through the payment terminal display or other user interface devices. In some embodiments, this information presented to the consumer requires a response from the consumer and the consumer can enter the response using the user interface device(s) integral with or coupled to the consumer's mobile device. In this way a consumer with a sensory impairment may be able to use his or her own device, which may be specially configured or at least familiar to the consumer, to receive and send communications to and from the payment terminal.

For example, in one embodiment, a consumer having a visual impairment is checking out at a grocery store and, when it is time to make payment, the payment terminal communicates wirelessly with the consumer's cell phone information including the total purchase amount and a request to select a method of payment from several available options. The consumer's cell phone may generate an audio signal to present this information to the consumer through headphones coupled to the cell phone. In response, the consumer may use the familiar keypad of the consumer's cell phone or a voice recognition feature of the cell phone to make a selection of a payment method. The cell phone then communicates the selection to the payment terminal. The consumer may then swipe a debit or credit card through a card reader of the payment terminal and, in response, the payment terminal may send a signal to the consumer's cell phone that causes the cell phone to present audio to the consumer asking the consumer to enter a personal identification number (PIN). The consumer can then use the cell phone's user input devices to enter a PIN.

In some embodiments of the invention, the payment terminal always wirelessly communicates the same information that is presented through its display or other consumer interface devices within some small radius of the payment terminal and always enables a mobile device in that radius to communicate consumer input back to the payment terminal. In other embodiments, however, communication between the consumer's mobile device and the payment terminal is only triggered by some event, such as input by a customer service person at the point of sale or recognition of a consumer preference associated with the consumer's rewards card or bank card.

In some embodiments of the invention, the payment terminal communicates the same information to the consumer's mobile device that is displayed to the consumer on the point of sale's display so that the information can be presented to the consumer using both the point of sale's display and the mobile device. In other embodiments, however, the payment terminal does not display the information on the payment terminal's display if the information is instead communicated to the consumer's mobile device. Likewise, in some embodiments of the invention, the payment terminal can receive consumer input from either the consumer's mobile device or the point of sale's user input devices, while, in other embodiments, the payment terminal can only receive certain consumer input from the mobile device once communication is initiated between the consumer's mobile device and the payment terminal.

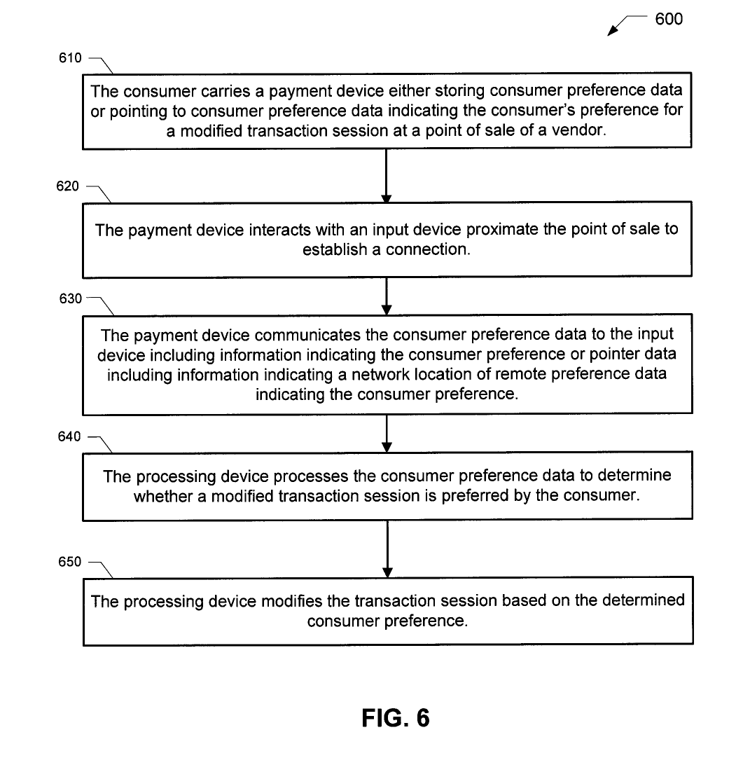

Referring now to FIG. 6, a flowchart of a process for providing a consumer a modified transaction process or session 600 is illustrated. First, as represented by block 610, a transaction device is carried by a consumer to the point of sale of a vendor and includes data indicating the consumer's preference for a modified transaction process such as one or more of the audible transaction process 100, the visual recognition audible transaction process 400, the mobile device consumer interface transaction process 500 each discussed above, or another modified transaction process.

A “transaction device” as used herein refers to any device used by the consumer to transfer or point to information useful to the vendor during a transaction proximate a point of sale. The term is intended to be read broadly to include many different types of devices such as loyalty devices, mobile devices, payment devices, and any other devices carried by a consumer during a transaction proximate a point of sale. When used herein, the term “payment device” is used synonymously with “transaction device” and is intended to include not only payment devices but also any other type of transaction devices as defined above. Examples of transaction or payment devices as used herein include, but are not limited to, loyalty devices such as loyalty cards or other loyalty devices, magnetic-based payment devices such as credit cards, debit cards, and the like, personal identification number (PIN) payment devices, contactless payment devices such as key fobs, radio frequency identification devices (RFID) and the like, and mobile devices such as smartphones, cellular phones, personal digital assistant (PDA) devices, MP3 devices, personal GPS devices and the like.

In some embodiments, the payment device includes a consumer preference device that stores consumer preference data corresponding to one or more consumer preferences regarding transaction sessions or other preferences. For example, in some embodiments, a consumer preference device may include one or more of a memory device, a communication device such as an RFID or a magnetic-based communication device such as a magnetic strip or the like. The consumer preference device is configured for communicating the consumer preference data to the payment terminal at the point of sale as discussed further below.

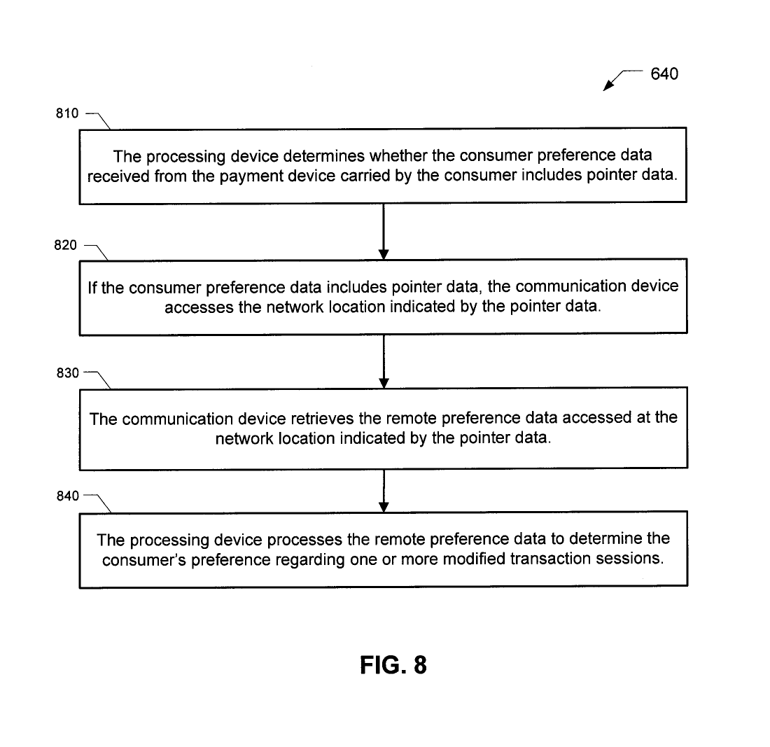

In other embodiments, the payment device includes a consumer preference device that stores pointer data indicating the location where consumer preference data is stored as discussed further below with reference to block 640 and FIG. 8. For example, in one embodiment, the pointer data includes a network address such as an address of a remote database at which the payment terminal can request the consumer preference data. Once the payment terminal has requested the consumer preference data, the remote database communicates the consumer preference data across the network to the payment terminal.

As represented by block 620, the payment device interacts with an input device of a payment terminal proximate the point of sale in order to establish a connection between the payment device and the payment terminal. Next, as represented by block 630, the payment device communicates the consumer preference data to the payment terminal. In some embodiments, the consumer preference data includes information indicating the consumer preference regarding a modified transaction process. In some other embodiments, the payment device communicates consumer preference data including pointer data including information indicating a network location of remote preference data. In these embodiments, the remote preference data indicates the consumer preference regarding a modified transaction process.

In yet other embodiments, the consumer preference data includes both information indicating the consumer preference regarding a modified transaction process and pointer data. The pointer data in such embodiments includes information indicating a network location of remote preference data that includes additional information regarding the consumer's preference regarding a modified transaction process. For example, in some embodiments, the consumer preference data indicates that a consumer prefers an audible transaction process 100 and also includes pointer data. The pointer data indicates the location of remote preference data, which indicates the additional consumer preferences regarding the audible transaction process 100 an the additional consumer preference for a visual recognition audible transaction process 400 in some embodiments or a mobile device consumer interface transaction process 500 in some embodiments or both in other embodiments.

As represented by block 640, the processing device of a payment terminal processes the consumer preference data to determine whether a modified transaction session is preferred by the consumer. In embodiments where pointer data is included with the consumer preference data, step 640 includes several sub-steps as discussed with reference to FIG. 8 below.

As represented by block 650, the processing device of the payment terminal modifies the transaction session based on the determined consumer preference regarding a modified transaction session. If, in step 640, it is determined the consumer prefers one or more modified transaction processes, the payment terminal modified the transaction to correspond to the consumer's preference. For example, in one embodiment, the consumer indicates to the consumer's bank his or her preference for an audible transaction process 100 during every transaction at points of sale. The bank issued a payment device having a consumer preference device such as a credit card having an embedded flash memory storing consumer preference data indicating the consumer's preference for an audible transaction process 100. For example, in another embodiment, the bank issues a credit card having an embedded flash memory storing consumer preference data including pointer data. When the credit card is read by an input device at the vendor's payment terminal or point of sale, the credit card communicates the consumer preference data including the pointer data to the payment terminal or point of sale. The payment terminal or point of sale then initiates the process discussed further with reference to FIG. 8 including retrieving and processing remote preference data. Once the consumer's preference for one or more modified transaction processes is determined, the payment terminal or point of sale modifies the transaction to accommodate the consumer's preference.

In some embodiments, the consumer's preference is for a modified transaction session throughout the entire transaction and in other embodiments, the consumer's preference is for a modified transaction session during only certain portions of the transaction. In some embodiments, the payment device communicates with the payment terminal at the point of sale before a transaction, in other embodiments during a transaction, and in others after a transaction. The consumer preference data in some embodiments includes the consumer preference for a modified transaction process during or throughout the present transaction and in others, includes the consumer preference for a modified transaction process in one or more future transactions.

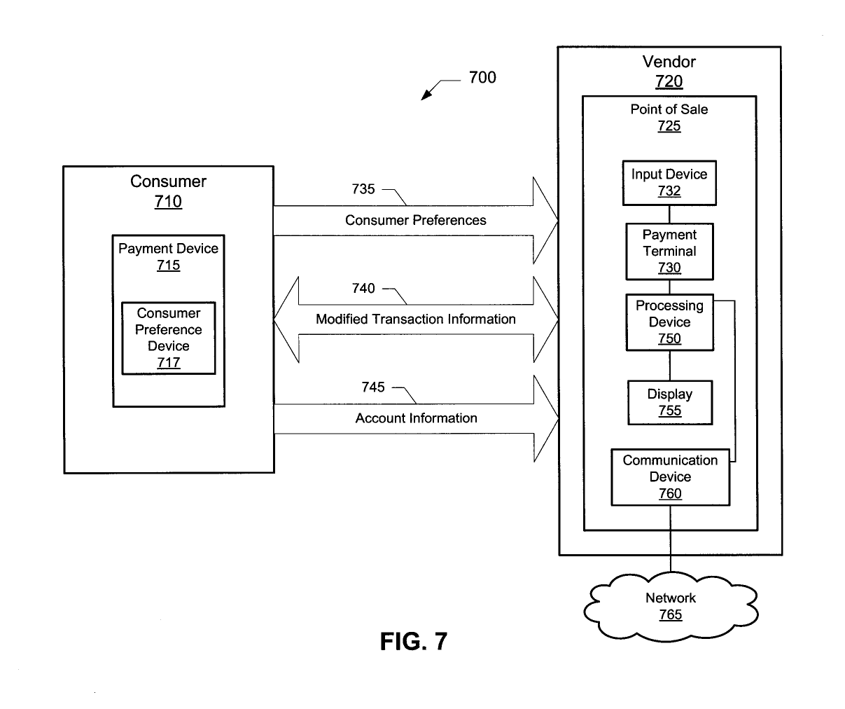

FIG. 7 is a block diagram providing a more detailed illustration of a system 700 for providing a consumer with a modified transaction process in accordance with another embodiment of the invention. The consumer 710 carries a payment device 715, which in some embodiments, includes a consumer preference device 717. As discussed above, the consumer preference device may include one or more of a memory device, a communication device such as an RFID or a magnetic-based communication device such as a magnetic strip or the like. The vendor 720 has a point of sale 725 which includes a payment terminal 730. An input device 732 interacts with the payment device 715 carried by the consumer in order to receive the consumer preference data regarding consumer preference for one or more modified transaction processes. As represented by arrow 735, the consumer preference data is communicated from the payment device 715 to the vendor 720 input device 732. A processing device 750 processes the consumer preference data in order to determine the consumer's preference regarding one or more modified transaction processes. In some embodiments, as discussed elsewhere, a communication device 760 communicates with a network 765 in order to retrieve remote preference data from a network location that was determined by processing the consumer preference data. Once it is determined the consumer prefers one or more modified transaction processes, modified transaction information is communicated from the vendor to the consumer as represented by arrow 740. Arrow 745 represents communication of payment account information from the consumer to the vendor during the transaction. Such information and other transaction interactions between the consumer and the vendor may be modified based on the consumer's preference for a modified transaction process.

In some embodiments, the payment device is not an “active” device that produces any type of communication, but rather, is a “passive” device that can be read by the payment terminal or point of sale. For example, in one embodiment, the payment device is or includes an RFID that can be detected by the input device at the payment terminal or point of sale. The RFID, in some embodiments, simply indicates a value such as a positive or negative value. In such embodiments, the input device is configured for recognizing and processing the value to indicate the consumer's preference for a particular modified transaction process. For example, the RFID indicates a positive value and the input device recognizes the positive value indicates the consumer's preference for an audible transaction process 100. Thus, the audible transaction process is initiated. In another example, the RFID indicates a positive value in addition to pointer data. In this example, the payment terminal retrieves the remote preference data and processes the data to determine the type of modified transaction process the consumer prefers. In yet other embodiments, the “passive” device may indicate consumer preference data including one or more positive or negative values corresponding to one or more modified transaction processes or may indicate one or more pieces of pointer data.

In other embodiments, the payment device is an “active” device that actively communicates the consumer preference data either automatically or upon recognizing the proximity of a payment terminal or point of sale input device.

Referring now to FIG. 8, a flowchart of processing the consumer preference data 680 is illustrated in accordance with one embodiment of the invention. As represented by block 810, the processing device determines whether the consumer preference data received from the payment device carried by the consumer includes pointer data. If the processing device determines the consumer preference data does not include pointer data, then the process 680 of FIG. 8 is exited and the processing device modifies the transaction session based on the consumer preference determined from the consumer preference data, if any (see 650 of FIG. 6). On the other hand, if the processing device determines the consumer preference data includes pointer data, the communication device accesses the network location indicated by the pointer data as represented by block 820. Next, as represented by block 830, the communication device retrieves the remote preference data accessed at the network location indicated by the pointer data. Finally, as represented by block 840, the processing device processes the remote preference data to determine the consumer's preference regarding one or more modified transaction sessions.

As will be appreciated by one of skill in the art, the present invention may be embodied as a method, apparatus (including a system), computer program product, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.”

Furthermore, embodiments of the present invention may take the form of a computer program product comprising a computer-readable storage medium having computer-usable program code/computer-readable instructions embodied in the medium. Any suitable computer-readable medium may be utilized. The computer-readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device; or transmission media such as those supporting the Internet or an intranet.

Computer-readable instructions for carrying out operations of the present invention may be written in an object-oriented, scripted or unscripted programming language such as Java, Perl, Smalltalk, C++, or the like. However, the computer-readable instructions for carrying out operations of the invention may also be written in conventional procedural programming languages, such as the “C” programming language or similar programming languages.

Embodiments of the present invention are described above with reference to flowchart illustrations and/or block diagrams of methods, apparatuses (systems) and computer program products according to embodiments of the invention. It will be understood that each block of the flowchart illustrations and/or block diagrams shown in FIGS. 1-4, and combinations of blocks in the flowchart illustrations and/or block diagrams, can be implemented by computer-readable instructions. These computer-readable instructions may be provided to a processor of a general purpose computer, a special purpose computer, or other programmable data processing apparatus to produce a machine, such that the instructions, which execute via the processor of the computer or other programmable data processing apparatus, create a mechanism for implementing the functions/acts specified in the flowchart and/or block diagram block or blocks.

These computer-readable program instructions may also be stored in a computer-readable memory that can direct a computer or other programmable data processing apparatus to function in a particular manner, such that the instructions stored in the computer-readable memory produce an article of manufacture including instruction mechanisms which implement the function/act specified in the flowchart and/or block diagram block or blocks.

The computer-readable program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A method for providing a modified transaction process between a consumer carrying a transaction device and a vendor during a transaction at a point of sale, the method comprising:
establishing, using an input device proximate the point of sale, a wired or wireless connection with the transaction device;
receiving, at the input device using the wired or wireless connection, consumer preference data from the transaction device carried by the consumer;
processing the consumer preference data to determine that the consumer prefers the modified transaction process; and
modifying the transaction based at least in part on the consumer preference for the modified transaction process.

2. The method of claim 1 wherein the consumer preference data received from the transaction device comprises information indicating the consumer preference regarding the modified transaction process.

3. The method of claim 1 wherein the consumer preference data received from the transaction device comprises pointer data including information indicating a network location of remote preference data indicating the consumer preference, and wherein processing the consumer preference data comprises accessing the network location, retrieving the remote preference data, and processing the remote preference data to determine the consumer preference regarding the modified transaction process.

4. The method of claim 1 wherein the modified transaction process comprises one or more selected from the group consisting of an audible transaction process, a visual recognition audible transaction process, and a mobile device consumer interface transaction process.

5. The method of claim 1 wherein the transaction device comprises one or more selected from the group consisting of loyalty devices, magnetic-based payment devices, credit cards, debit cards, personal identification number (PIN) payment devices, contactless payment devices, key fobs, radio frequency identification devices (RFID), mobile devices, smartphones, cellular phones, personal digital assistant (PDA) devices, Moving Picture Experts Group Layer-3 Audio (MP3) devices, and personal global positioning system (GPS) devices.

6. The method of claim 1 wherein the consumer preference data is received from the transaction device of the consumer proximate an onset of the transaction and the consumer preference for the modified transaction process is determined proximate the onset of the transaction such that substantially all of the transaction is modified based at least in part on the consumer preference for the modified transaction process.

7. The method of claim 1 wherein processing the consumer preference data includes determining the consumer's preference for the modified transaction process for a future transaction.

8. An apparatus for providing a modified transaction process between a consumer carrying a transaction device and a vendor during a transaction at a point of sale, the apparatus comprising:
means for establishing a wired or wireless connection with the transaction device;
means for receiving, the wired or wireless connection, consumer preference data from the transaction device carried by the consumer;
means for processing the consumer preference data to determine that the consumer prefers the modified transaction process; and
means for modifying the transaction based at least in part on the consumer preference for the modified transaction process.

9. The apparatus of claim 8 wherein the consumer preference data received from the transaction device comprises information indicating the consumer preference regarding the modified transaction process.

10. The apparatus of claim 8 wherein the consumer preference data received from the transaction device comprises pointer data including information indicating a network location of remote preference data indicating the consumer preference and wherein the apparatus further comprises means for accessing the network location, means for retrieving the remote preference data, and means for processing the remote preference data to determine the consumer preference regarding the modified transaction process.

11. The apparatus of claim 8 wherein the modified transaction process comprises one or more selected from the group consisting of an audible transaction process, a visual recognition audible transaction process, and a mobile device consumer interface transaction process.

12. The apparatus of claim 8 wherein the transaction device comprises one or more selected from the group consisting of loyalty devices, magnetic-based payment devices, credit cards, debit cards, personal identification number (PIN) payment devices, contactless payment devices, key fobs, radio frequency identification devices (RFID), mobile devices, smartphones, cellular phones, personal digital assistant (PDA) devices, Moving Picture Experts Group Layer-3 Audio (MP3) devices, and personal global positioning system (GPS) devices.

13. A system for providing a modified transaction process between a consumer carrying a transaction device and a vendor during a transaction at a point of sale, the system comprising:
a payment terminal disposed proximate the point of sale, the payment terminal comprising:
an input device configured for:
establishing a wired or wireless connection with the transaction device; and
receiving, the wired or wireless connection, consumer preference data from the transaction device carried by the consumer;
a processing device configured for processing the consumer preference data to determine that the consumer prefers the modified transaction process; and
the processing device further configured for modifying the transaction based at least in part on the consumer preference for the modified transaction process.

14. The system of claim 13 wherein the consumer preference data received by the input device from the transaction device comprises information indicating the consumer preference regarding the modified transaction process.

15. The system of claim 13 wherein the consumer preference data received by the input device from the transaction device comprises pointer data including information indicating a network location of remote preference data indicating the consumer preference,
and wherein the payment terminal further comprises a communication device configured for accessing the network location and retrieving the remote preference data,
and wherein the processing device is further configured for processing the remote preference data to determine the consumer preference regarding the modified transaction process.

16. The system of claim 13 wherein the modified transaction process comprises one or more selected from the group consisting of an audible transaction process, a visual recognition audible transaction process, and a mobile device consumer interface transaction process.

17. The system of claim 13 wherein the transaction device comprises one or more selected from the group consisting of loyalty devices, magnetic-based payment devices, credit cards, debit cards, personal identification number (PIN) payment devices, contactless payment devices, key fobs, radio frequency identification devices (RFID), mobile devices, smartphones, cellular phones, personal digital assistant (PDA) devices, Moving Picture Experts Group Layer-3 Audio (MP3) devices, and personal global positioning system (GPS) devices.

18. The system of claim 13 wherein the transaction device comprises a consumer preference device configured for storing and communicating the consumer preference data.

19. A computer program product comprising a computer-readable medium, the computer-readable medium comprising computer-readable instructions for providing a modified transaction process between a consumer carrying a transaction device and a vendor during a transaction at a point of sale, the instructions comprising:
instructions for establishing a wired or wireless connection with the transaction device;
instructions for receiving, using the wired or wireless connection, consumer preference data from the transaction device carried by the consumer;
instructions for processing the consumer preference data to determine that the consumer prefers the modified transaction process; and
instructions for modifying the transaction based at least in part on the consumer preference for the modified transaction process.

20. The computer program product of claim 19 wherein the consumer preference data received from the transaction device comprises information indicating the consumer preference regarding the modified transaction process.

21. The computer program product of claim 19 wherein the consumer preference data received from the transaction device comprises pointer data including information indicating a network location of remote preference data indicating the consumer preference and wherein the instructions further comprise:
instructions for accessing the network location;
instructions for retrieving the remote preference data; and
instructions for processing the remote preference data to determine the consumer preference regarding the modified transaction process.

22. The computer program product of claim 19 wherein the instructions for modifying the transaction comprise one or more selected from the group consisting of instructions for performing an audible transaction process, instructions for performing a visual recognition audible transaction process, and instructions for performing a mobile device consumer interface transaction process.

23. The computer program product of claim 19 wherein the transaction device comprises one or more selected from the group consisting of loyalty devices, magnetic-based payment devices, credit cards, debit cards, personal identification number (PIN) payment devices, contactless payment devices, key fobs, radio frequency identification devices (RFID), mobile devices, smartphones, cellular phones, personal digital assistant (PDA) devices, Moving Picture Experts Group Layer-3 Audio (MP3) devices, and personal global positioning system (GPS) devices.

24. A system disposed at a point of sale of a vendor for providing a modified transaction process between a consumer carrying a transaction device and the vendor during a transaction at the point of sale, the system comprising:
an input device configured for:
establishing a wired or wireless connection with the transaction device;
receiving, using the wired or wireless connection, consumer preference data from the transaction device carried by the consumer;
a processing device configured for processing the consumer preference data to determine that the consumer prefers the modified transaction process; and
the processing device further configured for modifying the transaction based at least in part on the consumer preference for the modified transaction process.

25. The system of claim 24 wherein the consumer preference data received by the input device from the transaction device comprises information indicating the consumer preference regarding the modified transaction process.

26. The system of claim 24 wherein the consumer preference data received by the input device from the transaction device comprises pointer data including information indicating a network location of remote preference data indicating the consumer preference,
and wherein the system further comprises a communication device configured for accessing the network location and retrieving the remote preference data,
and wherein the processing device is further configured for processing the remote preference data to determine the consumer preference regarding the modified transaction process.

27. The system of claim 24 wherein the modified transaction process comprises one or more selected from the group consisting of an audible transaction process, a visual recognition audible transaction process, and a mobile device consumer interface transaction process.

28. The system of claim 24 wherein the transaction device comprises one or more selected from the group consisting of loyalty devices, magnetic-based payment devices, credit cards, debit cards, personal identification number (PIN) payment devices, contactless payment devices, key fobs, radio frequency identification devices (RFID), mobile devices, smartphones, cellular phones, personal digital assistant (PDA) devices, Moving Picture Experts Group Layer-3 Audio (MP3) devices, and personal global positioning system (GPS) devices.

29. The system of claim 24 further comprising a payment terminal configured for receiving payment information from the consumer and finalizing the transaction.

30. The system of claim 24 wherein the transaction device comprises a consumer preference device configured for storing and communicating the consumer preference data.
